(19) United States
(12) Patent Application Publication
(10) Pub. No.: US 2008/0045305 A1
(43) Pub. Date: Feb. 21, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/598,628

(22) Filed: Nov. 14, 2006

Related U.S. Application Data
(60) Provisional application No. 60/838,361, filed on Aug. 18, 2006.

(51) Int. Cl. A63F 13/00

(52) U.S. Cl. 463/20

(57) ABSTRACT

When identical symbols are stopped at both ends of a cross line that is set as a payline, and subsequently a winning combination formed by symbols “BELL” or the like is realized on this cross line, a second payout table for generating a greater payout than a first payout table used ordinarily is selected, and payout of coins is made. Consequently, when the identical symbols are stopped at both ends of the cross line, it is possible to arouse the expectation of getting a greater payout in the player.

### CROSS-REFERENCE TO RELATED APPLICATION

This application is based upon and claims the benefit of U.S. Provisional Application No. 60/838,361, filed on Aug. 18, 2006; the entire contents of which are incorporated herein by reference.

### BACKGROUND OF THE INVENTION

1. Field of the Invention

The present invention relates to a slot machine for playing games by using a game medium such as coin or bill, and a playing method thereof.

2. Description of Related Art

In the conventional slot machines such as those disclosed in U.S. Pat. No. 6,960,133 and U.S. Pat. No. 6,012,983, when a player inserts the game medium such as medal, coin or bill into an insertion slot of the slot machine and presses a spin button, a plurality of symbols are displayed as a scrolling display at a display unit provided on a front side of a cabinet, and then each symbol is automatically stopped.

At this point, by generating random numbers at a time of starting the scrolling display of each symbol which is triggered by the input of the spin button, a payout of coins or credit associated with a prize such as the mystery bonus is made, or a transition from a base game to a bonus game is made and a bonus game is executed when a transition to a bonus game such a second game is determined, arbitrarily.

Then, the slot machine is configured to pay out a prize according to the winning state generated in the course of the game.

In such a conventional slot machine, the symbols displayed by the scrolling display are automatically stopped.

### SUMMARY OF THE INVENTION

The first aspect of the present invention is a slot machine comprising: a display having a rectangular display region in which a plurality of symbols can be arranged and at least two paylines set in the display region on diagonal lines of the display region; and a controller operable to rearrange symbols in the display region, and enable a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region.

According to the slot machine of the first aspect of the present invention, when the identical symbols are rearranged at both ends of each one of two paylines on the diagonal lines, the symbols are rearranged by accepting the external input at the intersection of these paylines. Also, a cross symbol, a wild symbol, or a jackpot symbol is set as a symbol that can be rearranged at this intersection, and the symbols are rearranged according to the external input.

The second aspect of the present invention is a slot machine comprising: a display having a rectangular display region in which a plurality of symbols can be arranged and at least two paylines set in the display region on diagonal lines of the display region; and a controller operable to rearrange symbols in the display region, enable a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region, and generate a greater payout when the identical symbols rearranged at both ends of each payline on one of the diagonal lines are rearranged on the each payline again, than that generated when the identical symbols are rearranged on a payline other than the paylines on the diagonal lines.

According to the slot machine of the second aspect of the present invention, it is made such that, after the identical symbols are rearranged at both ends of the payline on the diagonal line, a greater payout is generated when the identical symbols are rearranged in other regions of this payline, than when the identical symbols are rearranged on another payline. Then, when the identical symbols are rearranged at both ends of the payline, there can be cases where a payout becomes greater.

The third aspect of the present invention is a slot machine comprising: a display having a rectangular display region in which a plurality of symbols can be arranged and at least two paylines set in the display region on diagonal lines of the display region; and a controller operable to rearrange symbols in the display region, enable a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region, generate a greater payout when the identical symbols rearranged at both ends of each payline on one of the diagonal lines are rearranged on the each payline again, than that generated when the identical symbols are rearranged on a payline other than the paylines on the diagonal lines, and subsequently to hold the identical symbols over a prescribed number of games when the identical symbols are rearranged at both ends of each one of the two paylines on the diagonal lines.

According to the slot machine of the third aspect of the present invention, when the identical symbols are rearranged at both ends of the payline on the diagonal line, these identical symbols are held in the next and subsequent games, and there are cases where a greater payout is generated in the next and subsequent games.

The fourth aspect of the present invention is a playing method of a slot machine comprising: rearranging symbols in a rectangular display region provided on a display by a controller; and enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region.

In the playing method using a slot machine of the fourth aspect of the present invention, when the identical symbols are rearranged at both ends of each one of two paylines on the diagonal lines, the symbols are rearranged by accepting the external input at the intersection of these paylines. Also, a cross symbol, a wild symbol, or a jackpot symbol is set as a symbol that can be rearranged at this intersection, and there are cases where the symbols are rearranged according to the external input.

The fifth aspect of the present invention is a playing method of a slot machine comprising: rearranging symbols in a rectangular display region provided on a display by a controller; enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region; and generating a greater payout by a controller when the identical symbols rearranged at both ends of each payline on one of the diagonal lines are rearranged on the each payline again, than that generated when the identical symbols are rearranged on a payline other than the paylines on the diagonal lines.

In the playing method using a slot machine of the fifth aspect of the present invention, it is made such that, after the identical symbols are rearranged at both ends of the payline on the diagonal line, a greater payout is generated when the identical symbols are rearranged in other regions of this payline, than when the identical symbols are rearranged on another payline.

The sixth aspect of the present invention is a playing method of a slot machine comprising: rearranging symbols in a rectangular display region provided on a display by a controller; enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region; generating a greater payout by a controller when the identical symbols rearranged at both ends of each payline on one of the diagonal lines are rearranged on the each payline again, than that generated when the identical symbols are rearranged on a payline other than the paylines on the diagonal lines; and subsequently holds the identical symbols over a prescribed number of games by a controller when the identical symbols are rearranged at both ends of each one of the two paylines on the diagonal lines.

In the playing method using a slot machine of the sixth aspect of the present invention, when the identical symbols are rearranged at both ends of the payline on the diagonal line, these identical symbols are held in the next and subsequent games.

### BRIEF DESCRIPTION OF THE DRAWINGS

FIG. 1 is a flow chart showing a playing method of a slot machine according to one embodiment of the present invention.

FIG. 2 is a diagram showing an outward appearance of a slot machine according to one embodiment of the present invention.

FIG. 3 is a diagram showing a series of symbols displayed in each display region of a slot machine according to one embodiment of the present invention and a code number of each symbol.

FIG. 4A is a diagram showing a first payout table that indicates a relationship between a winning combination and a payout amount, and FIG. 4B is a diagram showing a second payout table that indicates a relationship between a winning combination and a payout amount.

FIG. 5 is a block diagram showing a control circuit of a slot machine according to one embodiment of the present invention.

FIG. 6 is a flow chart showing a procedure of an authentication and reading processing of a game program and a game system program by a mother board and a gaming board of a slot machine according to one embodiment of the present invention.

FIG. 7 is a flow chart showing a first half of a procedure of a base game processing to be executed by a slot machine according to one embodiment of the present invention.

FIG. 8 is a flow chart showing a second half of a procedure of a base game processing to be executed by a slot machine according to one embodiment of the present invention.

FIG. 9 is a flow chart showing a procedure of a stop control game processing to be executed by a slot machine according to one embodiment of the present invention.

FIG. 10 is a flow chart showing a first variation of a procedure of a stop control game processing to be executed by a slot machine according to one embodiment of the present invention.

FIG. 11 is a flow chart showing a second variation of a procedure of a stop control game processing to be executed by a slot machine according to one embodiment of the present invention.

FIG. 12 is a flow chart showing a procedure of a symbols to be stopped determination processing to be executed by a slot machine according to one embodiment of the present invention.

FIG. 13 is a flow chart showing a procedure of a symbols scrolling display processing to be executed by a slot machine according to one embodiment of the present invention.

FIG. 14 is a flow chart showing a procedure of a bonus game processing to be executed by a slot machine according to one embodiment of the present invention.

FIG. 15 is a diagram showing an exemplary display for notifying that a stop control game is executed in a slot machine according to one embodiment of the present invention.

FIG. 16 is a diagram showing an exemplary display to be displayed in each display region of a liquid crystal display in a slot machine according to one embodiment of the present invention.

FIG. 17 is a diagram showing an exemplary display to be displayed in each display region of a liquid crystal display in a slot machine according to one embodiment of the present invention.

FIG. 18 is a diagram showing an exemplary display to be displayed in each display region of a liquid crystal display in a slot machine according to one embodiment of the present invention.

FIG. 19 is a diagram showing an exemplary display to be displayed in each display region of a liquid crystal display in a slot machine according to one embodiment of the present invention.

FIG. 20 is a diagram showing an exemplary display to be displayed in each display region of a liquid crystal display in a slot machine according to one embodiment of the present invention.

FIG. 21 is a diagram showing an exemplary display to be displayed in each display region of a liquid crystal display in a slot machine according to one embodiment of the present invention.

FIG. 22 is a diagram showing an exemplary display to be displayed in each display region of a liquid crystal display in a slot machine according to one embodiment of the present invention.

FIG. 23 is a diagram showing a display region of five rows by five columns in a slot machine according to one embodiment of the present invention.

### DETAILED DESCRIPTION OF THE EMBODIMENT

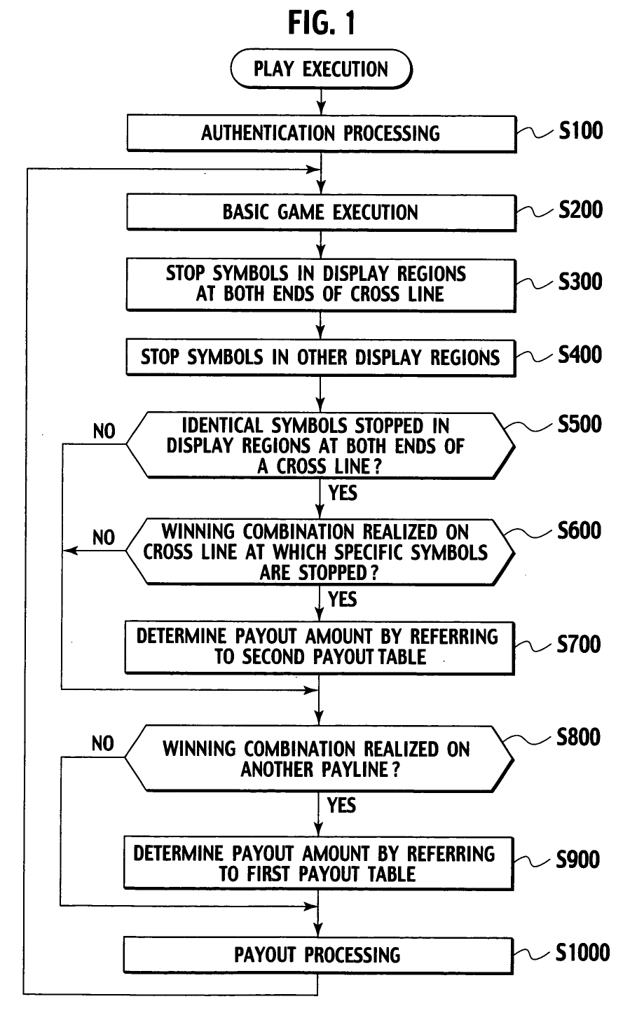

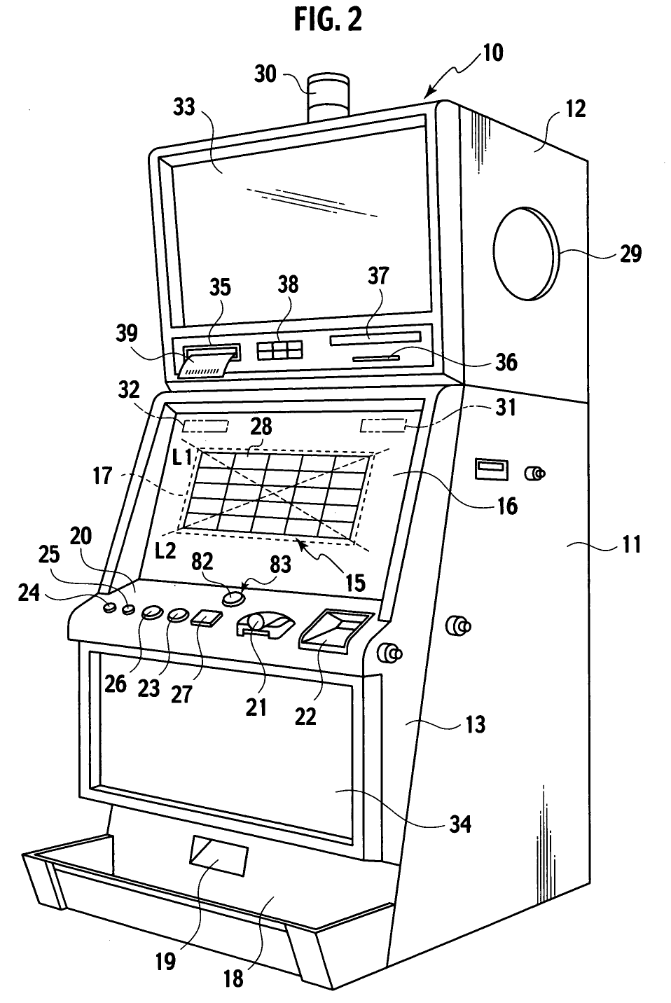

FIG. 1 is a flow chart schematically showing a playing method of a slot machine according to an embodiment of the present invention. In the following, the schematic operations in the slot machine and the playing method according to the embodiment will be described with references to the flow chart shown in FIG. 1 and a diagram shown in FIG. 2.

In the slot machine according to the embodiment, when the power is turned on and the slot machine is activated, an authentication processing is carried out first (step S100). In this authentication processing, the initial checking processing at a preliminary stage before starting a base game (unit game), such as whether a program for operating the system is operating normally or not, whether there is any alteration of a program or not, etc., is carried out.

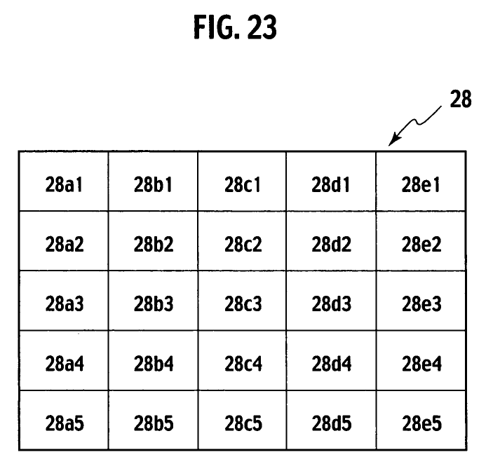

Next, a base game is executed (step S200). On a front face of a cabinet 11, a display window 15 is provided, and in 25 display regions 28 (28a1 to 28e5) of five rows and five columns of a liquid crystal display 17 inside the display window 15, respective symbols are displayed (arranged). Note that the suffix “a to e” attached to the reference numeral “28” of the display regions 28 indicates columns, and the suffix “1 to 5” indicates rows (see FIG. 23).

Then, in the base game, when a spin button 23 is pressed in a state where a desired credit amount is bet by entering coins into a coin slot 21 or the like, the symbols displayed in the display regions 28 (28a1 to 28e5) are scrolled, and after a prescribed time has elapsed, the symbols are stopped (rearranged) at both ends of the cross lines that are set as paylines (see L1 and L2 in FIG. 2), that is, in the display regions 28a1, 28a5, 28e1 and 28e5 at four corners among the 25 display regions 28 (28a1 to 28e5) provided in a matrix shape (step S300). In this state, the symbols at both ends of the two cross lines are stopped. Note that, besides the above described cross lines L1 and L2, five rows in the horizontal direction and five columns in the vertical direction are also set as the paylines.

After that, when the time further elapsed, the symbols scrolled in the display regions 28 other than those at four corners are stopped (step S400).

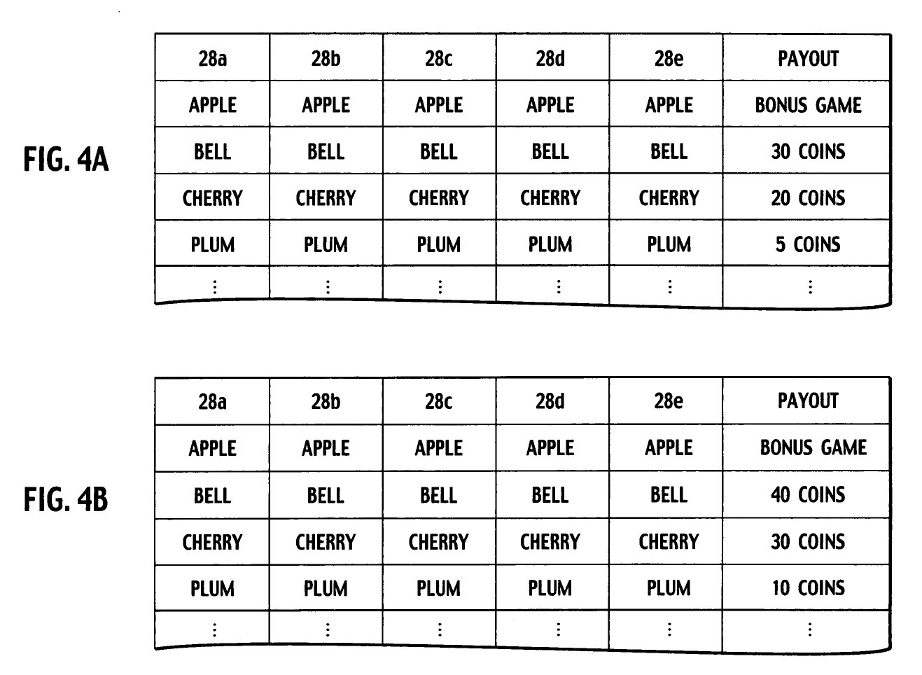

Then, whether the identical symbols are stopped at both ends of two cross lines or not is judged (step S500). In the case where the identical symbols are stopped, whether the winning combination is realized on the cross line or not is judged further (step S600), and in the case where the winning combination is realized, the payout amount for the realization of this winning combination is determined by referring to the second payout table (see FIG. 4B) which is set to make a greater payout amount than the first payout table that is ordinarily used (step S700).

Next, whether the winning combination is realized on the other payline (paylines other than the cross lines) or not is judged (step S800). Then, when it is judged that the winning combination is realized, the payout amount for the realization of this winning combination is determined by referring to the first payout table (see FIG. 4A)(step S900).

After that, the payout of the total of the payout amounts determined by the step S700 and the step S900 is made (step S1000).

In this way, in the present embodiment, when the identical symbols are stopped at both ends of the cross lines, and when the winning combination is realized on the cross line after that, the payout amount is determined by referring to the second payout table which is set to make a greater payout amount, so that it is possible to obtain a greater payout.

Note that, in the above, an exemplary case of displaying symbols by using the display regions 28 provided in 5×5 matrix shape has been described, but the present invention is not limited to this case.

Next, a configuration of the slot machine 10 according to one embodiment of the present invention will be described with reference to a diagram shown in FIG. 2. The slot machine 10 is provided within a gaming facility.

In the slot machine 10, the coins, bills or electronic value information corresponding to these will be used as the game medium for executing the base game (unit game). However, the game medium that can be used in the present invention is not limited to these, and can be medals, tokens, electronic money, or tickets, for example. The tickets are not limited to any particular tickets and can be tickets with bar codes, for example, as will be described below.

As shown in FIG. 2, the slot machine 10 has a cabinet 11, a top box 12 provided on an upper side of the cabinet 11, and a main door 13 provided on a front side of the cabinet 11.

Inside the cabinet 11, a liquid crystal display 17 for scrolling a plurality of symbols inside the display window 15 formed by a transparent material is provided, and the liquid crystal display (display) 17 has the display regions 28 (28a1 to 28e5; see FIG. 23) for displaying symbols of five rows by five columns. Consequently, it is made such that the symbols displayed in the display regions 28 are visible to the player through the display window 15. In the present embodiment, when the base game is executed, among the symbols displayed in the display regions 28 (28a1 to 28e5) of five rows by five columns, the symbols in the display regions 28 (28a1, 28a5, 28e1, 28e5) at four corners at both ends of the cross lines are stopped first, and after that, the symbols in the other display regions 28 are sequentially stopped. Then, it is made such that, in the case where the winning combination is realized on the cross line that is recognized as the payline, a greater payout than that in the case where the winning combination is realized on the other payline is generated.

Note that, the present embodiment uses an exemplary case of using the display regions 28 (28a1 to 28e5) of five rows and five columns of the liquid crystal display 17 as the display, but the present invention is not limited to this case.

On a front side of the liquid crystal display 17 in the main door 13, a lower side image display panel 16 is provided. The lower side image display panel 16 has a transparent liquid crystal panel, on which various information regarding the game and the effect images will be displayed during the game.

On the lower side image display panel 16, a credit amount display unit 31 and a payout amount display unit 32 are provided. On the credit amount display unit 31, the number of coins credited is displayed by an image. On the payout amount display unit 32, the number of coins to be paid in the case where the winning combination is realized as will be described below is displayed by an image.

The winning combination is a combination of symbols when the identical symbols are stopped on any of five lines in the vertical direction, five lines in the horizontal direction, and two lines in oblique directions, in the display regions 28 (28a1 to 28e5) provided in a 5×5 matrix shape, for example. In the case where such a winning combination is stopped in the display regions 28, the prescribed number of coins will be paid. Also, the number of coins to be paid is increased as the BET number increases, so that when the number of coins to be paid for the BET number of one coin is five coins, the number of coins to be paid for the BET number of two coins will be ten coins.

On the lower side image display panel 16, the display window 15, through which symbols displayed in the display regions 28 (28a1 to 28e5) of five rows by five columns of the liquid crystal display 17 provided therein are visible, is provided.

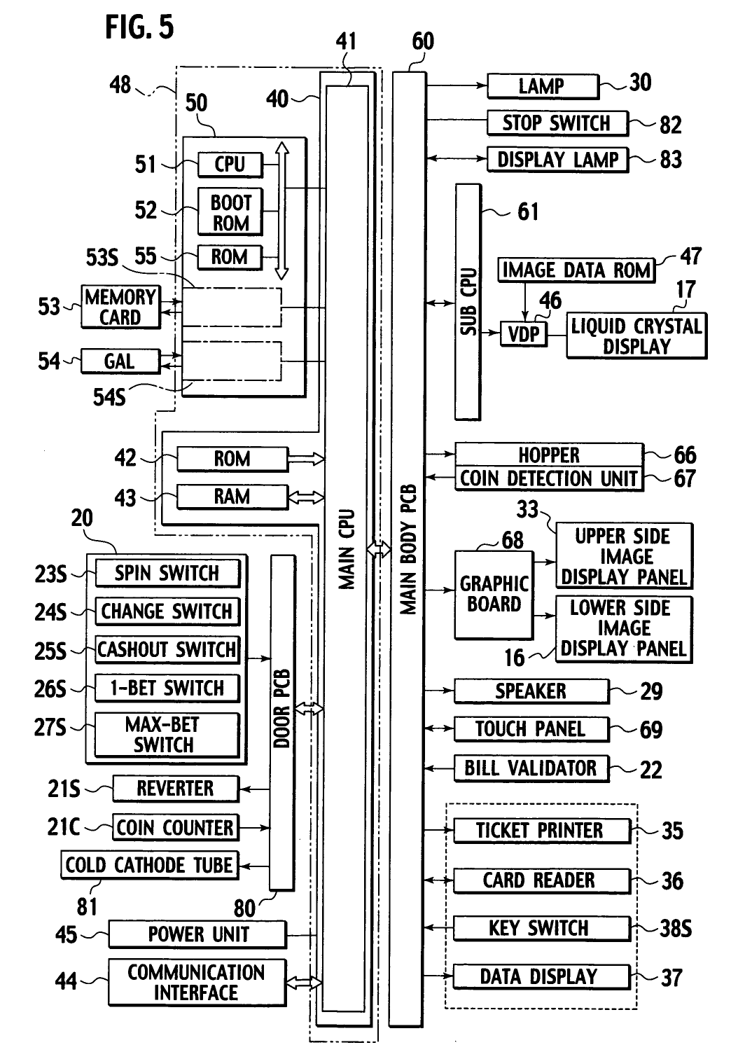

In addition, on a front face of the lower side image display panel 16, a touch panel 69 (see FIG. 5) is provided, such that the player can input various types of commands by operating the touch panel 69.

On a lower side of the lower side image display panel 16, a control panel 20 having a plurality of buttons 23-27 through which commands regarding the progress of the game will be inputted by the player, the coin slot 21 for receiving coins into the cabinet 11, and a bill validator 22 are provided. In addition, a stop switch 82 to be operated by the player when the stop control game to be described below is started, and a display lamp 83 which is provided integrally with this stop switch 82 and which is turned on when the stop switch is set active, are provided.

On the control panel 20, a spin button 23, a change button 24, a cashout button 25, a 1-BET button 26, and a Max-BET button 27 are provided. The spin button 23 is a button for inputting a command for start scrolling symbols displayed in the display regions 28. The change button 24 is a button to be used at a time of requesting changes to an attendant of the gaming facility. The cashout button 25 is a button for inputting a command for paying the credited coins to a coin tray 18.

The 1-BET button 26 is a button for inputting a command for betting one coin among the credited coins to the game. The Max-BET button 27 is a button for inputting a command for betting maximum number (50, for example) of coins that can be bet per game among the credited coins to the game.

The bill validator 22 validates whether a bill is the legitimate one or not and accepts a legitimate bill into the cabinet 11. Note that the bill validator 22 may have a configuration capable of reading a bar code attached ticket 39 to be described below. On the lower front surface of the main door 13, that is on the lower part of the control panel 20, there is provided a berry glass 34 on which characters of the slot machine 10 and the like are depicted.

On a front surface of the top box 12, an upper side image display panel 33 is provided. The upper side image display panel 33 has a liquid crystal panel, on which the effect image or the image for introducing the game content or explaining game rules, for example, will be displayed.

Also, on the top box 12, a speaker 29 for outputting speech is provided. On the lower side of the upper side image display panel 33, a ticket printer 35, a card reader 36, a data display 37, and a key pad 38 are provided. The ticket printer 35 prints a bar code which encodes data such as the credit amount, the date and time, the identification number of the slot machine 10, etc., on the ticket, and outputs it as the bar code attached ticket 39. The player can use the bar code attached ticket 39 to play the game on another slot machine or exchange the bar code attached ticket 39 with the bills or the like at the cashier or the like of the gaming facility.

The card reader 36 carries out reading of data from a smart card and writing of data into a smart card. The smart card is a card to be owned by the player, which stores data for identifying the player or data regarding log of games played by the player, for example.

The data display 37 comprises a fluorescent display or the like, on which data read by the card reader 36, or data inputted by the player through the key pad 38, for example, will be displayed. The key pad 38 inputs data and commands regarding the ticket issuance or the like.

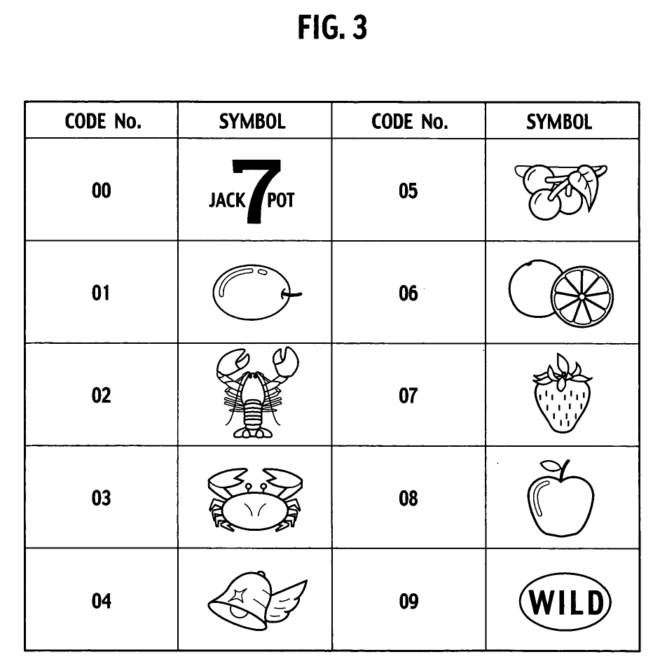

FIG. 3 is a diagram showing symbols to be scrolled in the display regions 28 provided in the liquid crystal display 17 inside the cabinet 11. As shown in FIG. 3, in each of the display regions 28, altogether ten types of symbols comprising the code numbers “00” to “09” are set, and each of these symbols will be scrolled. Note that these symbols will be scrolled randomly, regardless of the-code numbers.

The symbols to be displayed in each of the display regions 28 include “JACKPOT 7”, “PLUM”, “LOBSTER”, “CRAB”, “BELL”, “CHERRY”, “ORANGE”, “STRAWBERRY”, “APPLE” and “WILD”. Then, the winning combination associated with a payout is set by a combination of the above described symbols. As a table for determining the payout amount when this winning combination is realized, a first payout table for determining a payout amount ordinarily, and a second payout table with a greater payout amount than the first payout table are set up.

FIG. 4A is a diagram showing the first payout table. In this first payout table, a transition to the bonus game will be made when five symbols “APPLE” are aligned. Also, the payout of 30 coins will be made when five symbols “BELL” are aligned, and the payout of 20 coins will be made when five symbols “CHERRY” are aligned.

On the other hand, FIG. 4B is a diagram showing the second payout table. In this second payout table, a transition to the bonus game will be made when five symbols “APPLE” are aligned. Also, the payout of 40 coins will be made when five symbols “BELL” are aligned, and the payout of 30 coins will be made when five symbols “CHERRY” are aligned.

FIG. 5 is a block diagram showing a control circuit of the slot machine 10 shown in FIG. 2. As shown in FIG. 5, the control circuit comprises a mother board 40, a main body PCB (Printed Circuit Board) 60, a gaming board 50, a sub CPU 61, a door PCB 80, and various types of switches and sensors. The mother board 40 and the gaming board 50 constitute a controller 48.

The gaming board 50 has a CPU (Central Processing Unit) 51, a ROM 55 and a boot ROM 52 which are mutually connected through an internal bus, a card slot 53S corresponding to a memory card 53, and an IC socket 54S corresponding to a GAL (Generic Array Logic) 54.

The memory card 53 stores a game program and a game system program. The game program includes a symbols to be stopped determination program. The symbols to be stopped determination program is a program for determining symbols (code numbers corresponding to symbols) to be stopped in the display regions 28 (28a1 to 28e5) of five rows by five columns. This symbols to be stopped determination program contains symbol weighing data respectively corresponding to plural types of payout rates (80%, 84%, 88%, for example). The symbol weighing data are data indicating the correspondence relationship between the code number of each symbol (see FIG. 3), and one or a plurality of random number values belonging to a prescribed numerical value range (0 to 256), for each of the display regions 28 (28a1 to 28e5) of five rows by five columns.

The payout rate is determined according to the payout rate setting data outputted from the GAL 54. The symbols to be stopped are determined according to the symbol weighing data corresponding to this payout rate.

Also, the card slot 53S is formed such that the memory card 53 can be inserted or extracted, and connected to the mother board 40 through the IDE bus. Consequently, by extracting the memory card 53 from the card slot 53S, writing the other game program and game system program into the memory card 53, and inserting that memory card 53 into the card slot 53S, it is possible to change a type and a content of the game to be played on the slot machine 10.

The game program includes a program related to the game progress and a program for making a transition to the bonus game. The game program also contains the image data and sound data to be outputted during the game.

The GAL 54 has a plurality of input ports and output ports, and when data are inputted into the input ports, data corresponding to these data are outputted from the output ports. The data outputted from the output ports are the payout rate setting data mentioned above.

Also, the IC socket 54S is formed such that the GAL 54 can be attached or detached, and connected to the mother board 40 through the PCI bus. Consequently, by detaching the GAL 54 from the IC socket 54S, rewriting the program stored in the GAL 54, and attaching that GAL 54 to the IC socket 54S, it is possible to change the payout rate setting data to be outputted from the GAL 54.

The CPU 51, the ROM 55 and the boot ROM 52 that are mutually connected through the internal bus are connected to the mother board 40 through the PCI bus. The PCI bus carries out the signal transmission between the mother board 40 and the gaming board 509, as well as the power supply from the mother board 40 to the gaming board 50. The ROM 55 stores a country identification information and an authentication program. The boot ROM 52 stores a spare authentication program and a program (boot codes) for the CPU 51 to activate the spare authentication program.

The authentication program is a program (alteration checking program) for authenticating the game program and the game system program. Namely, the authentication program is a program for carrying out the checking and the verification of the fact that the game program and the game system program are not altered. The authentication program is described along a procedure for carrying the authentication of the game program and the game system program. The spare authentication program is a program for authenticating the above described authentication program. The spare authentication program is described along a procedure for carrying out the verification that the authentication program that is a target of the authentication processing is not altered, that is, the authentication of the authentication program.

The mother board 40 has a main CPU 41, a ROM (Read Only Memory) 42, a RAM (RandomAccess Memory) 43, and a communication interface 44.

The main CPU 41 has a function for controlling the entire slot machine 10. In particular, the main CPU 41 carries out a control for stopping symbols first in the display regions at both ends of the cross lines (L1 and L2 shown in FIG. 2) which become the paylines in the oblique directions among the display regions 28 of the liquid crystal display 17, that is, the display regions 28a1, 28a5, 28e1 and 28e5 at four corners, and then stopping symbols in the other display regions 28, with respect to the sub CPU 61 when the credit is bet and the spin button 23 is pressed, a control for determining the payout amount by using the second payout table (a table with a greater payout amount than the first payout table) when the symbols constituting the winning combination are stopped on the cross line, and a control for determining the payout amount by using the first payout table when the symbols constituting the winning combination are stopped on the other payline.

Also, when the identical symbols are stopped at both ends of the cross line L1 or L2, the main CPU 41 carries out a control for holding these symbols over a plurality of base games.

In addition, when the identical symbols are stopped at both ends of the cross line, the main CPU 41 carries out a control for executing the stop control game for stopping symbols in relation to the input of the operation of the stop switch by the player, in the display region 28c3 at a center of this cross line.

Also, when the identical symbols are stopped at both ends of each of the two cross lines L1 and L2 but the symbols stopped at the both ends are different for the two cross lines, the main CPU 41 carries out a control for setting cross symbols that can be commonly used for the symbols stopped at both ends of the two cross lines L1 and L2, to be capable of being stopped in the display region 28c3 at which the two cross lines L1 and L2 intersect.

The ROM 42 stores programs such as BIOS (Basic Input/Output System) to be executed by the main CPU 41, as well as data to be used permanently. When the BIOS is executed by the main CPU 41, the processing for initializing each peripheral device is carried out and the processing for reading the game program and the game system program stored in the memory card 53 through the gaming board 50 is started.

The RAM 43 stores data and programs to be used when the main CPU 41 carries out the processing.

The communication interface 44 carries out communications with the host computer or the like that is provided inside the gaming facility through a communication channel.

Also, to the Mother board 40, a main body PCB (Printed Circuit Board) 60 and a door PCB 80 to be described below are connected through the respective USB (Universal Serial Bus). In addition, a power source unit 45 is connected to the mother board 40. When the power is supplied from the power source unit 45 to the mother board 40, the main CPU 41 of the mother board 40 is activated, and the power is supplied to the gaming board 50 through the PCI bus and the CPU 51 is activated.

To the main body PCB 60 and the door PCB 80, devices for generating input signals to be inputted into the main CPU 41 and devices whose operations are to be controlled by control signals outputted from the main CPU 41 are connected. The main CPU 41 carries out the calculation processing by executing the game program and the game system program stored in the RAM 43 according to the input signals inputted into the main CPU 41 and stores its result into the RAM 43, and carries out the processing for transmitting control signals to each device as the control processing with respect to each device.

To the main body PCB 60, a lamp 30, a sub CPU 61, a hopper 66, a coin detection unit 67, a graphic board 68, a speaker 29, a touch panel 69, a bill validator 22, a ticket printer 35, a card reader 36, a key switch 38S, and a data display 37 are connected. In addition, the stop switch 82 and the display lamp 83 that is integrally provided with the stop switch 82 are connected.

The sub CPU 61 carries out a control for scrolling symbols in the 25 display regions 28 (28a1 to 28e5) of five rows by five columns set in the liquid crystal display 17, and then stopping them, upon receiving the command from the main CPU 41. The sub CPU 61 is connected to a VDP (Video Display Processor) 46.

The VDP 46 reads out the image data of symbols stored in the image data ROM 47, generates the scrolling images to be displayed at the liquid crystal display 17, and outputs the scrolling images to the liquid crystal display 17, under the control of the sub CPU 61.

The hopper 66 is provided inside the cabinet 11, and pays the prescribed number of coins according to the control signal outputted from the main CPU 41, from a coin payout opening 19 to a coin tray 18. The coin detection unit 67 is provided inside the coin payout opening 19, and outputs an input signal with respect to the main CPU 41 when it is detected that the prescribed number of coins are paid from the coin payout opening 19.

The graphic board 68 controls the image display on the upper side image display panel 33 and the lower side image display panel 16 other than the symbols displayed in the display regions 28, according to the control signal outputted from the main CPU 41. On the credit amount display unit 31 of the lower side image display panel 16, the credit amount stored in the RAM 43 is displayed. On the payout amount display unit 32 on the lower side image display panel 16, the number of coins to be paid is displayed. The graphic board 68 has a VDP for generating image data according to the control signal outputted from the main CPU 41 and a video RAM for temporarily storing the image data generated by the VDP.

The bill validator 22 reads an image of the bill and accepts the legitimate bill into the cabinet 11. The bill validator 22 outputs an input signal with respect to the main CPU 41 according to the amount of that bull when the legitimate bill is accepted. The main CPU 41 stores the credit amount according to the amount of the bill notified by that input signal into the RAM 43.

The ticket printer 35 prints the bar code which encodes data such as the credit amount stored in the RAM 43, the date and time, and the identification number of the slot machine 10, etc., on the ticket, according to the control signal outputted from the main CPU 41, and outputs it as the bar code attached ticket 39.

The card reader 36 reads data from the smart card and transmit it to the main CPU 41, or writes data into the smart card according to the control signal outputted from the main CPU 41. The key switch 38S is provided on the key pad 38, and outputs an input signal to the main CPU 41 when the key pad 38 is operated by the player.

The data display 37 displays the data read by the card reader 36 or the data inputted by the player through the key pad 38, according to the control signal outputted from the main CPU 41.

To the door PCB 80, a control panel 20, a reverter 21S, a coin counter 21C and a cold cathode tube 81 are connected. On the control panel 20, a spin switch 23S corresponding to a spin button 23, a change switch 24S corresponding to a change button 24, a cashout switch 25S corresponding to a cashout button 25, a 1-BET switch 26S corresponding to a 1-BET button 26, and a Max-BET switch 27S corresponding to a Max-BET button 27 are provided. Each one of the switches 23S to 27S outputs an input signal with respect to the main CPU 41 when the corresponding one of the buttons 23-27 is operated by the player.

The coin counter 21C is provided inside the coin slot 21, and validates whether coins entered at the coin slot 21 are legitimate ones or not. Those coins that are not the legitimate ones will be ejected from the coin payout opening 19. The coin counter 21C outputs an input signal with respect to the main CPU 41 when the legitimate coins are detected.

The reverter 21S is operated according to a control signal outputted from the main CPU 41, to distribute the coins recognized as the legitimate coins by the coin counter 21C to the cash box (not shown) provided inside the slot machine 10 or the hopper 66. Namely, when the hopper 66 is filled with coins, the legitimate coins are distributed to the cash box by the reverter 21S. On the other hand, when the hopper 66 is not filled with coins, the legitimate coins are distributed to the hopper 66.

The cold cathode tube 81 functions as the background light provided on the back side of the lower side image display panel 16 and the upper side image display panel 33, and it is turned on according to a control signal outputted from the main CPU 41.

The stop switch 82 is set active when the stop control game to be described below is started, and inputs the operation for stopping symbols scrolled in the central display region 28c3 of the 5×5 display regions 28. Also, the display lamp 83 is turned on when the stop switch 82 is set active.

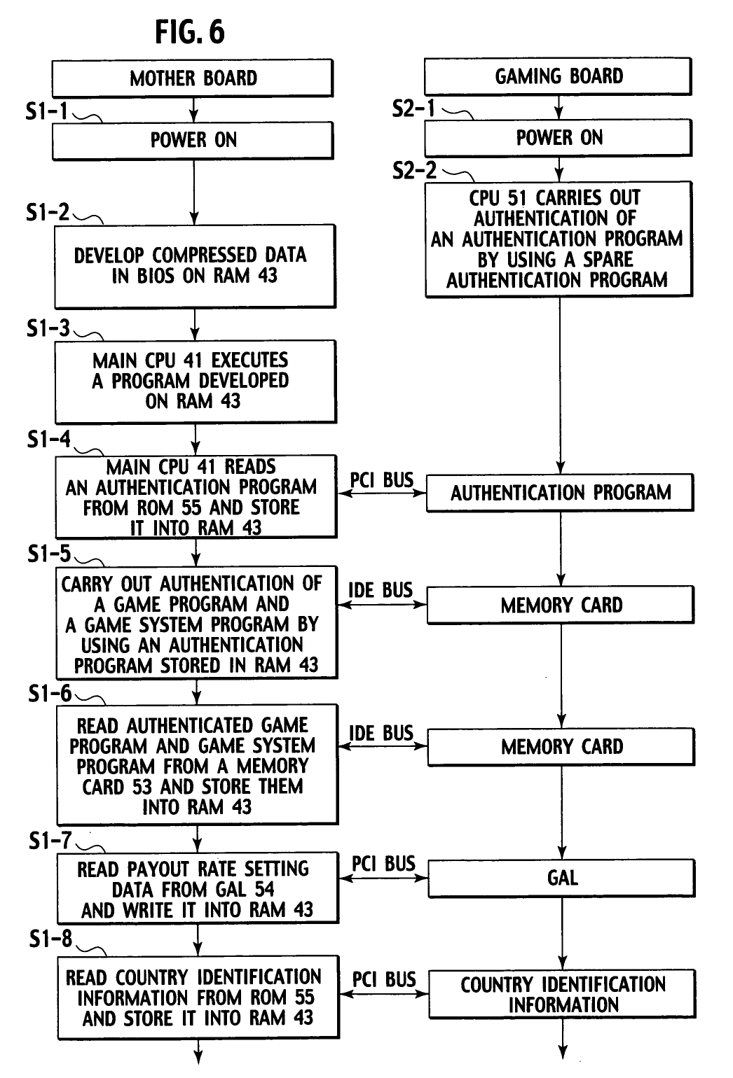

Next, the concrete processing to be carried out at the slot machine 10 will be described. FIG. 6 is a flow chart showing a procedure of the authentication and reading processing for the game program and the game system program (processing at the step S100 shown in FIG. 1), by the mother board 40 and the gaming board 50 shown in FIG. 5. Here it is assumed that the memory card 53 is attached to the card slot 53S and the GAL 54 is attached to the IC socket 54S on the gaming board 50.

First, when the power switch is turned on at the power source unit 45, the mother board 40 and the gaming board 50 are activated (steps S1-1, S2-1). When the motherboard 40 and the gaming board 50 are activated, the respective independent processings will be carried out in parallel. Namely, at the gaming board 50, the CPU 51 carries out the reading of the spare authentication program stored in the boot ROM 52, and the spare authentication for checking and verifying that the authentication program is not altered in advance, according to the read out spare authentication program, before it is taken into the mother board 40 (step S2-2).

On the other hand, at the mother board 40, the main CPU 41 executes the BIOS stored in the ROM 42 and expands the compressed data incorporated in the BIOS over the RAM 43 (step S1-2). Then, the main CPU 41 executes the BIOS expanded on the RAM 43 to carry out the diagnosis and initialization of various types of peripheral devices (step S1-3).

Then, as the ROM 55 of the gaming board 50 is connected to the main CPU 41 through the PCI bus, the main CPU 41 carries out the reading of the authentication program stored in the ROM 55. In addition, the main CPU 41 carries out the processing for storing the read out authentication program into the RAM 43 (step S1-4).

Next, the main CPU 41 makes an access to the memory card 53 that is attached to the card slot 53S through the IDE bus. Then, the main CPU 41 carries out the reading of the game program and the game system program stored in the memory card 53.

Next, the main CPU 41 carries out the authentication for checking and verifying that the read out game program and game system program are not altered, according to the authentication program stored in the RAM 43 (step S1-5).

When this authentication processing is finished normally, the main CPU 41 stores the authenticated game program and game system program into the RAM 43 (step S1-6). Next, the main CPU 41 makes an access to the GAL 54 that is attached to the IC socket 54S through the PCI bus, reads out the payout rate setting data from the GAL 54, and stores it into the RAM 43 (step S1-7). Next, the main CPU 41 carries out the reading of the country identification information stored in the ROM 55 of the gaming board 50, and stores the read out country identification information into the RAM. 43 (step S1-8).

After carrying out the above described processing, the main CPU 41 sequentially reads out and executes the game program and the game system program, to proceed with the base game as described below.

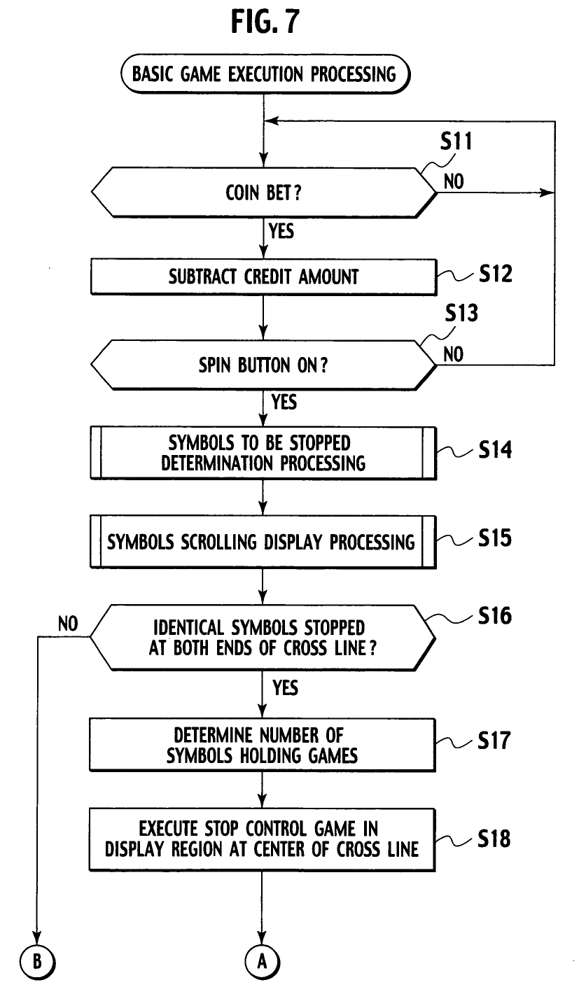

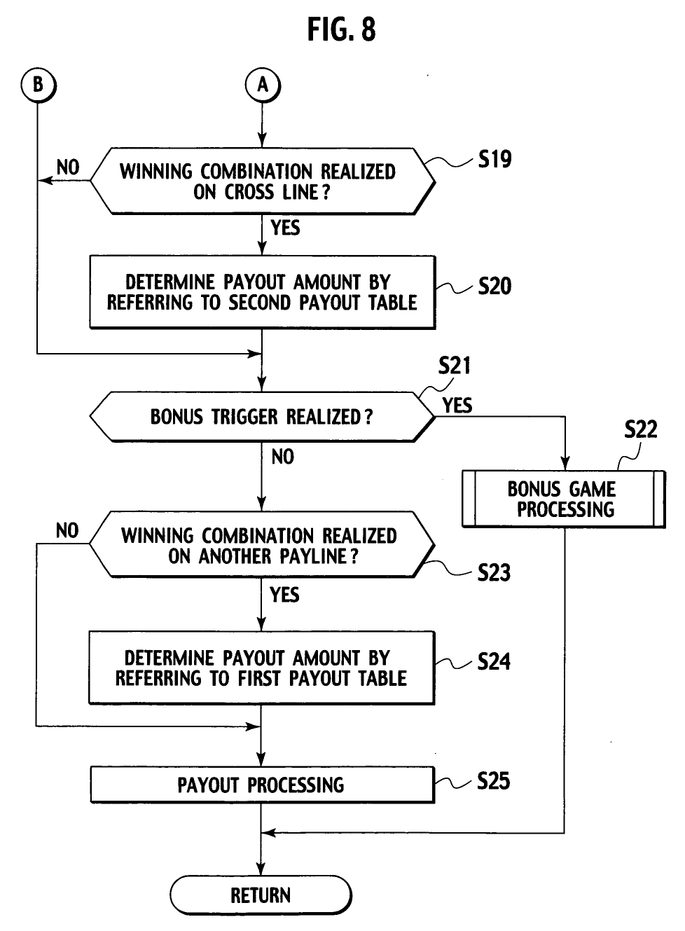

After the authentication and reading processing shown in FIG. 6 is carried out, the main CPU 41 carries out the base game execution processing. FIG. 7 and FIG. 8 are a flow chart showing the concrete processing procedure of the base game execution processing.

In the base game execution processing, first the main CPU 41 judges whether the coin BET has been made or not (step S11). In this processing, the main CPU 41 judges whether the input signal outputted from the 1-BET switch 26S when the 1-BET button 26 is pressed or the input signal outputted from the Max-BET switch 27S when the Max-BET button 27 is pressed has been received or not. When it is judged that the coin BET has not been made, the processing returns to the step S11.

On the other hand, at the step S1, when it is judged that the coin BET has been made, the main CPU 41 carries out the processing for subtracting the credit amount stored in the RAM 43 according to the number of coins to be bet (step S12). When the number of coins to be bet is greater than the credit amount stored in the RAM 43, the processing is returned to the step S11, without carrying out the processing for subtracting the credit amount stored in the RAM 43. When the number of coins to be bet exceeds the upper limit value (50 in the first embodiment) that can be bet per one game, the processing proceeds to the step S13, without carrying out the processing for subtracting the credit amount stored in the RAM 43.

Next, the main CPU 41 judges whether the spin button 23 is turned ON or not (step S13). In this processing, the main CPU 41 judges whether the input signal outputted from the spin switch 23S when the spin button 23 is turned ON is received or not.

When it is judged that the spin button 23 is not turned ON, the processing is returned to the step S1. In the case where the spin button 23 is not turned ON (the case where a command indicating the finishing of the game is inputted without turning the spin button 23 ON, for example), the main CPU 41 cancels the subtraction result at the step S12.

In the present embodiment, the exemplary case of carrying out the processing for subtracting the credit amount (step S12) after the coin BET is made (step S11), before making the judgement as to whether the spin button 23 is turned ON or not (step S13) will be described. However, the present invention is not limited to this exemplary case. For example, it is also possible to make the judgement as to whether the spin button 23 is turned ON or not (step S13) after the coin BET is made (step S11), and carry out the processing for subtracting the credit amount (step S12) when it is judged that the spin button 23 is turned ON (step S13 YES).

Then, at the step S13 of FIG. 7, when it is judged that the spin button 23 is turned ON, the main CPU 41 carries out the symbols to be stopped determination processing for determining symbols to be stopped and displayed in the display regions 28 (28a1 to 28e5) of five rows by five columns (step S14). This symbols to be stopped determination processing will be described below.

Next, the main CPU 41 carries out the symbols scrolling display processing for scrolling symbols in the display regions 28 (28a1 to 28e5)(step S15). This symbols scrolling display processing will be described below.

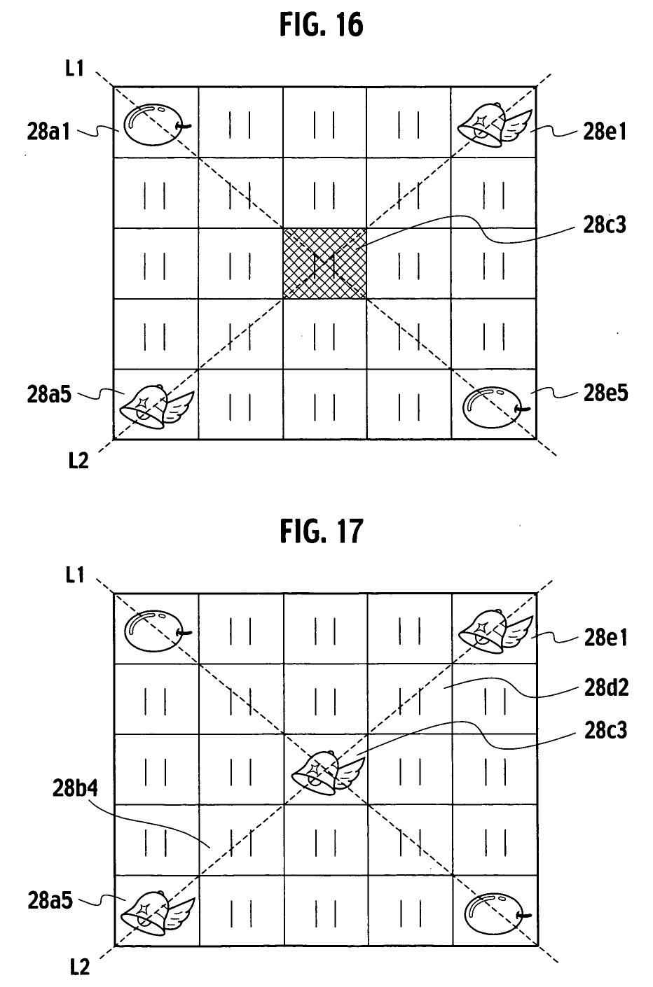

Then, when the scrolling of symbols is started, after a prescribed time has elapsed, symbols are stopped in the display regions 28a1, 28a5, 28e1 and 28e5 provided at four corners. The main CPU 41 judges whether the identical symbols have stopped at both ends of the cross lines (cross lines L1 and L2 of FIG. 2) set in the display regions 28 that are provided in a matrix shape as a result of stopping symbols or not (step S16). For example, as shown in FIG. 16, in the case where the symbols “PLUM” are stopped in the upper left and lower right display regions 28a1 and 28e5 and the symbols “BELL” are stopped at the lower left and upper right display regions 28a5 and 28e1, it is YES at the step S16, so that the main CPU 41 determines a number of games over which the symbols stopped at the four corners are to be held (step S17). For example, when the number of games for holding is determined to be “5”, the symbols “PLUM” and “BELL” at the four corners will be held in the subsequent five games. Also, when the identical symbols are not stopped at both ends of the cross lines L1 and L2, the processing proceeds to the step S21 (FIG. 8).

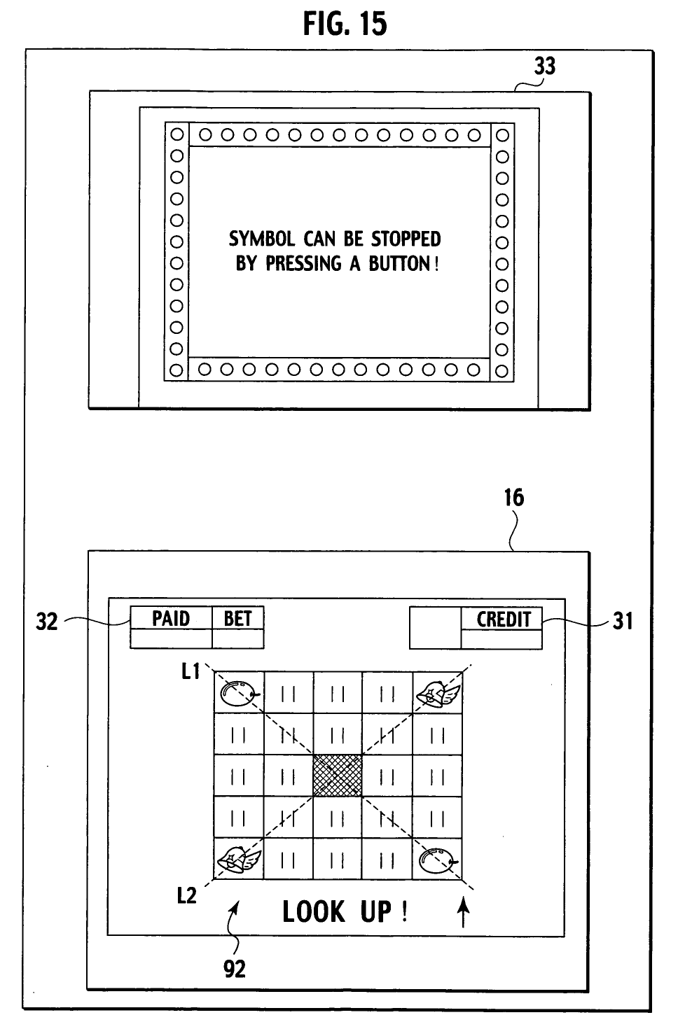

When the processing of the step S17 is finished, the main CPU 41 executes the stop control game for a symbol in the central display region 28c3 of the cross line (step S18). In the stop control game, the operation of the stop button 82 by the player is accepted, and the symbol scrolled in the display region 28c3 is stopped in relation to the timing of the operation of the stop button 82. At this point, as shown in FIG. 15, letters “Symbol can be stopped by pressing a button” are displayed in the upper side image display panel 33, and further an image 92 of letters “LOOK UP!” is displayed in the lower side image display panel 16 to direct the player's attention to the upper side image display panel 33, as shown in FIG. 15. Further details will be described below.

Next, after the symbol is stopped in the display region 28c3 by the stop control game, the main CPU 41 stops symbols scrolled in the other display regions 28 (that is, the display regions other than those at the four corners and the center), and judges whether the winning combination is realized on either one of the cross lines L1 and L2 as a result or not (step S19). For example, when the symbols “BELL” are stopped in the lower left and upper right display regions 28a5 and 28e1, the symbol “BELL” is stopped in the central display region 28c3 by the stop control game, and further the symbols “BELL” are stopped in the remaining two display regions 28b4 and 28d2 that constitute the cross line L2 as shown in FIG. 17, it is judged that the winning combination is realized on the cross line L2. In this case, the payout amount of coins is determined by using the second payout table shown in FIG. 4B (step S20). More specifically, it is determined that the payout amount of coins is 40 coins.

Next, the main CPU 41 judges whether the bonus trigger is realized or not (step S21). More specifically, whether five symbols “APPLE” are stopped on the payline in the display regions 28 or not is judged, and when five symbols “APPLE” are aligned, the bonus game processing is executed (step S22). The bonus game processing will be described below.

On the other hand, when it is judged that the bonus trigger is not realized (step S21 NO), the main CPU 41 judges whether the winning combination is realized on the payline other than the cross lines L1 and L2 or not (step S23). Here, when it is judged that the winning combination is realized (step S23 YES), the main CPU 41 determines the payout amount of coins by referring to the first payout table shown in FIG. 4A (step S24). For example, when five symbols “CHERRY” are aligned on the payline, it is determined that the payout amount of coins is 20 coins.

After that, the main CPU 41 carries out the payout processing for paying the total of the payout amount determined by the step S20 and the payout amount determined by the step S24 (step S25). In this way, the base game is executed.

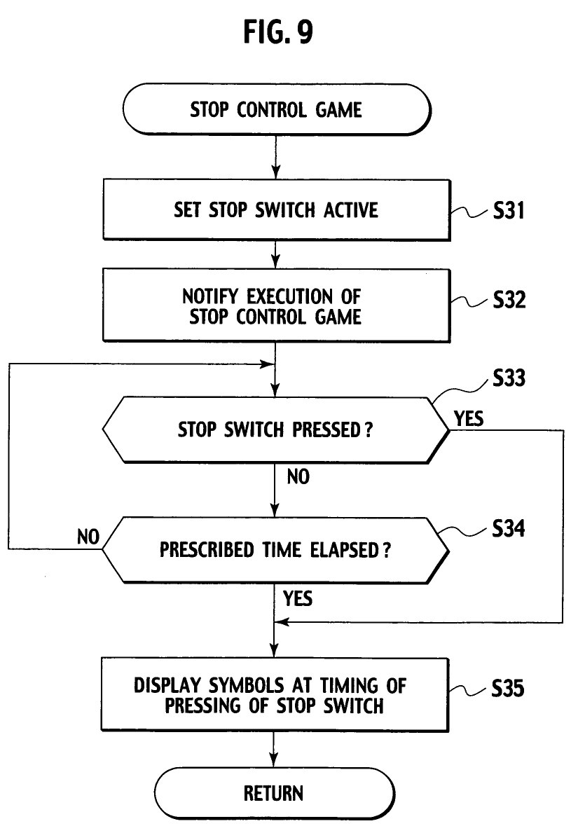

Next, the concrete processing procedure of the stop control game shown at the step S18 of FIG. 7 will be described with reference to a flow chart shown in FIG. 9. When the stop control game is started, first, the main CPU 41 sets the operation input by the stop switch 82 active (step S31). Then, the display lamp 83 that is provided integrally with the stop switch 82 is turned on, so as to notify the player that the stop switch 82 is set active. At the same time, as shown in FIG. 15, letters “Symbol can be stopped by pressing a button” are displayed, so as to notify the player that the symbol scrolled in the display region 28c3 can be stopped by pressing the stop switch 82 (step S32).

After that, the main CPU 41 judges whether the stop switch 82 is pressed or not, and when the stop switch 82 is pressed (step S33 YES) or a prescribed time has elapsed (step S34 YES), the scrolled symbol is stopped at a timing of the pressing of the stop switch 82 or at a timing of having a prescribed time elapsed (step S35).

As a result, in the case where the symbol “BELL” is stopped in the central display region 28c3 as shown in FIG. 17, for example, the possibility for realizing the winning combination on the cross line L2 becomes high, and in the case where the symbols “BELL” are stopped in the remaining display regions 28b4 and 28d2 that constitute the cross line L2 after that, the payout of coins using the second payout table will be made.

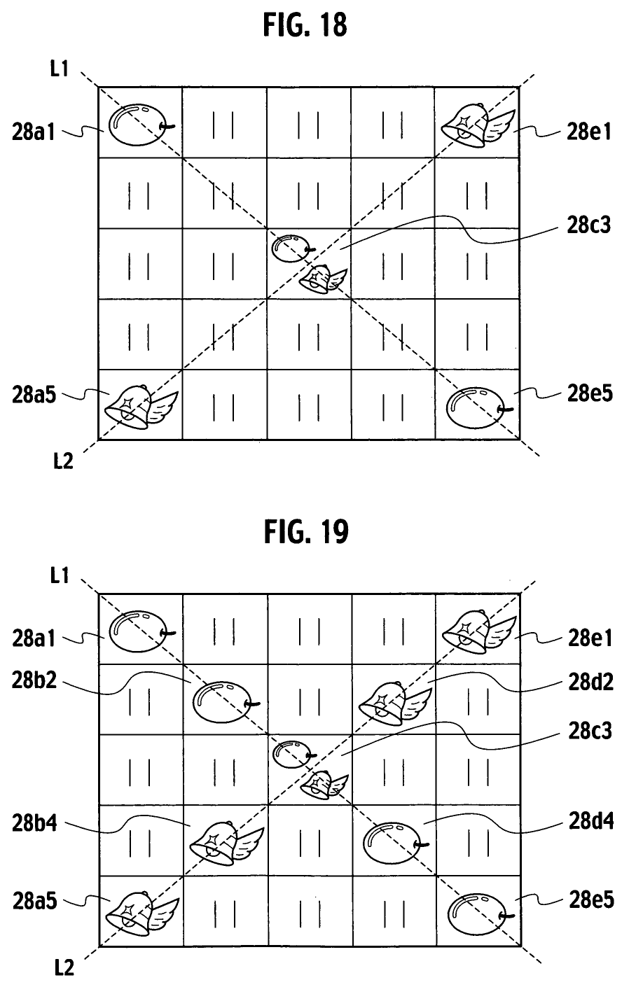

Also, it may be made such that the cross symbol of “PLUM” and “BELL” is included in the symbol to be scrolled in the central display region 28c3 as shown in the display region 28c3 of FIG. 18, such that this cross symbol can be stopped by executing the stop control game. In this case, if the cross symbol of “PLUM” and “BELL” can be stopped in the central display region 28c3, the possibility for realizing the winning combinations on both of the two cross lines L1 and L2 becomes high. Then, in the case where the symbols “PLUM” are stopped in the display regions 28b2 and 28d4 and the symbols “BELL” are stopped in the display regions 28b4 and 28d2 as shown in FIG. 19, the winning combinations are realized on both of the two cross lines L1 and L2, so that the payout of the total of these will be generated.

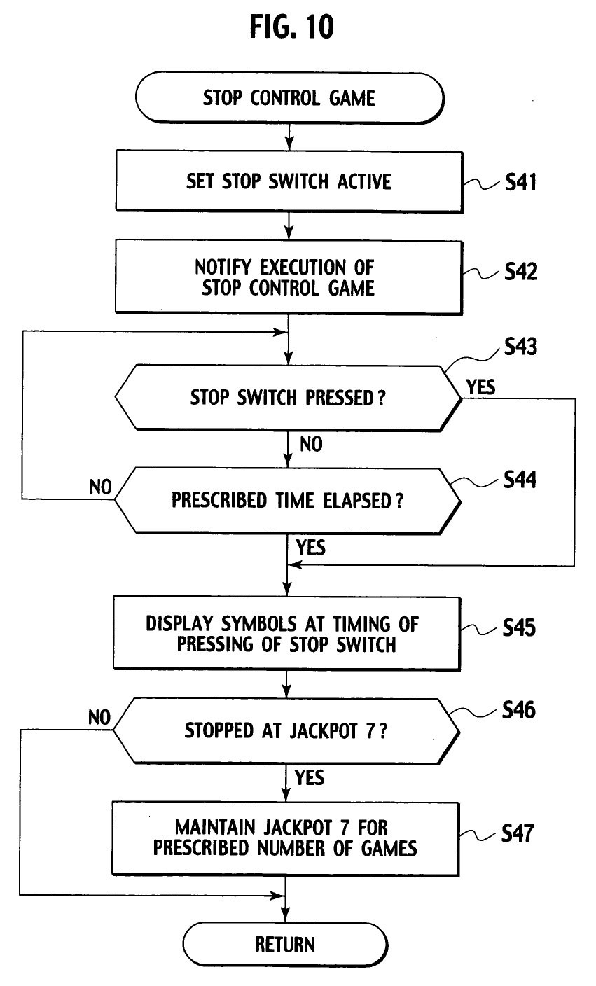

FIG. 10 is a flow chart showing the processing operation in the first variation of the stop control game. When the stop control game is started, first, the main CPU 41 sets the operation input by the stop switch 82 active (step S41). Then, the display lamp 83 that is provided integrally with the stop switch 82 is turned on, so as to notify the player that the stop switch 82 is set active, and further, as shown in FIG. 15, letters “Symbol can be stopped by pressing a button” are displayed (step S42).

After that, the main CPU 41 judges whether the stop switch 82 is pressed or not, and when the stop switch 82 is pressed (step S43 YES) or a prescribed time has elapsed (step S44 YES), the scrolled symbol is stopped at a timing of the pressing of the stop switch 82 or at a timing of having a prescribed time elapsed (step S45). At this point, the symbol “JACKPOT 7” is included in the symbol scrolled in the display regions 28c3.

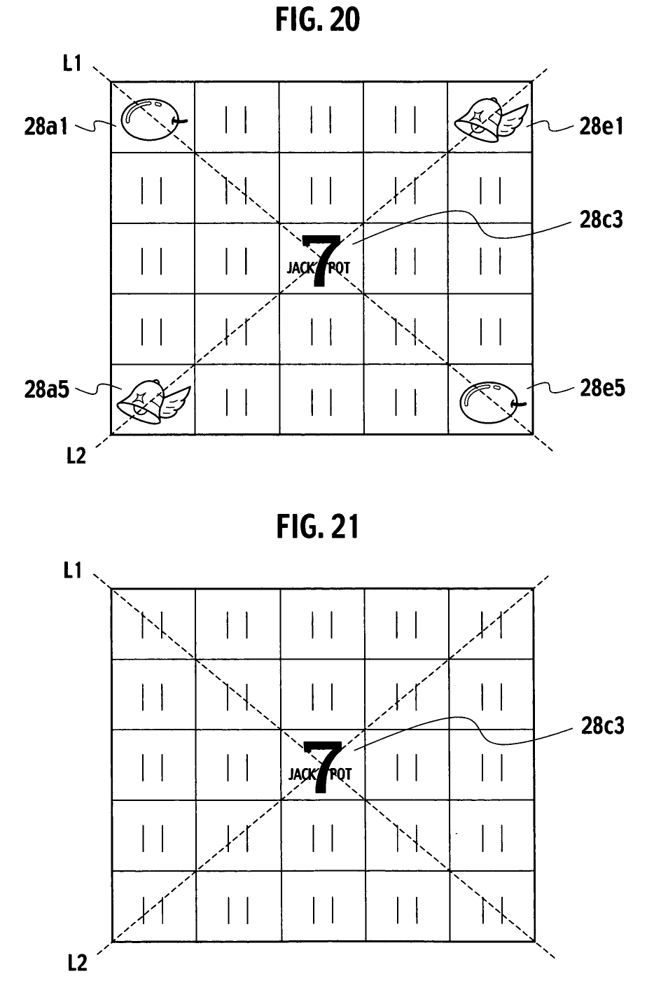

As a result, in the case where the symbol “JACKPOT 7” is stopped in the central display region 28c3 as shown in FIG. 20, for example, this symbol “JACKPOT 7” is held over a prescribed number of subsequent base games (step S47). Namely, in the next base game, the scrolling in the other display regions 28 will be started in a state where the symbol “JACKPOT 7” is stopped in the central display region 28c3 as shown in FIG. 21.

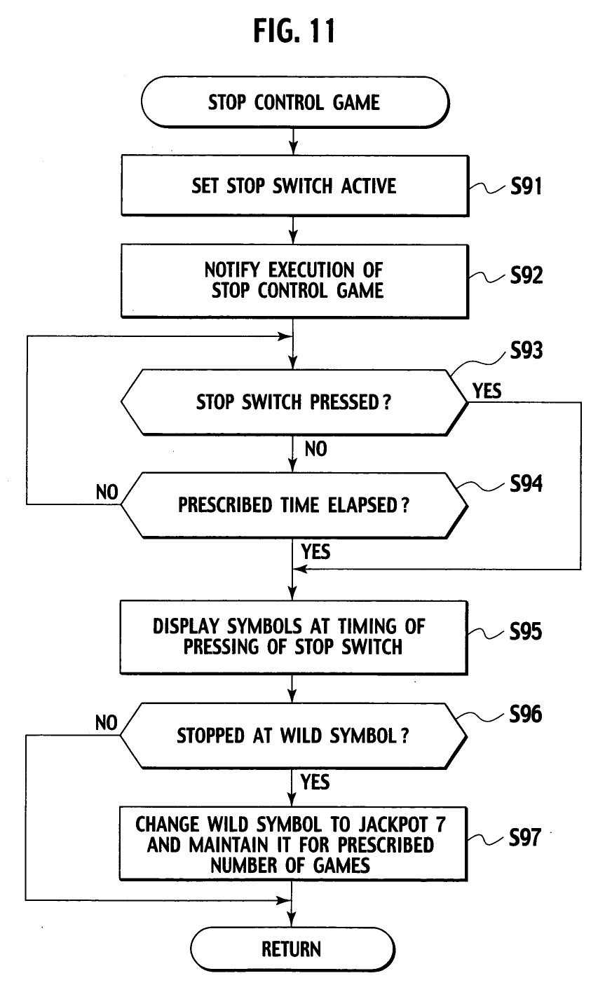

FIG. 11 is a flow chart showing the processing operation in the second variation of the stop control game. The steps S91 to S95 shown in FIG. 11 are the same as the steps S41 to S45, so that their description will be omitted. In this second variation, when the stop control game is executed, the symbol “WILD” is included in the symbol scrolled in the display regions 28c3. The symbol “WILD” is a symbol that can be used as matching with any symbol.

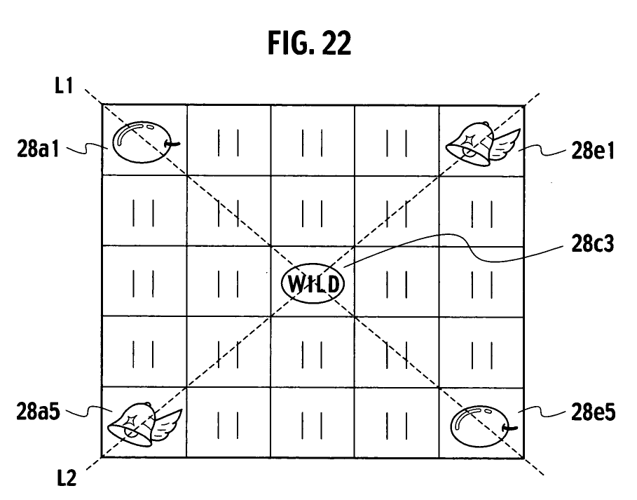

As a result of having the stop switch pressed by the processing of the step S95, in the case where the symbol “WILD” is stopped in the central display region 28c3 as shown in FIG. 22, whether the winning combination including this “WILD” symbol is, realized on each payline or not is judged.

Also, the symbol “WILD” that is stopped in the central display region 28c3 is changed to the symbol “JACKPOT 7” and held in a prescribed number of the subsequent base games. Consequently, in the next base game, the scrolling in the other display regions 28 will be started in a state where the symbol “JACKPOT 7” is stopped in the central display region 28c3 as shown in FIG. 21.

In this way, the stop control game shown at the step S14 of FIG. 7 is executed.

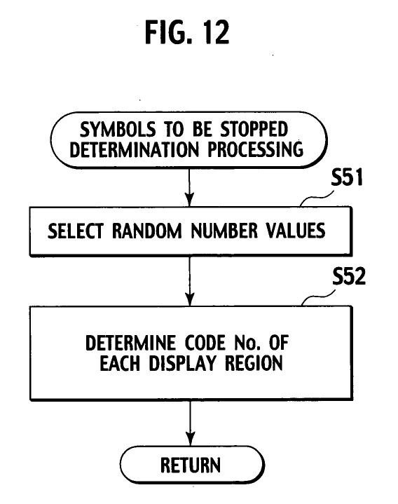

Next, the symbols to be stopped determination processing shown at the step S14 of FIG. 7 will be described with reference to a flow chart shown in FIG. 12. FIG. 12 is a flow chart showing a procedure of the symbols to be stopped determination processing shown at the step S14 of FIG. 7. This processing is a processing to be carried out as the main CPU 41 executes the symbols to be stopped determination program stored in the RAM 43.

First, the main CPU 41 selects a random number value corresponding to each display region 28 (28a1 to 28e5) from a numerical value range of 0 to 255, by executing the random number generation program contained in the symbols to be stopped determination program (step S51).

Next, the main CPU 41 refers to the symbol weighing data according to the payout rate setting data outputted from the GAL 54 and stored in the RAM 43, and determines the code numbers (see FIG. 3) for the display regions 28 (28a to 28e) according to the selected random number values (step S52).

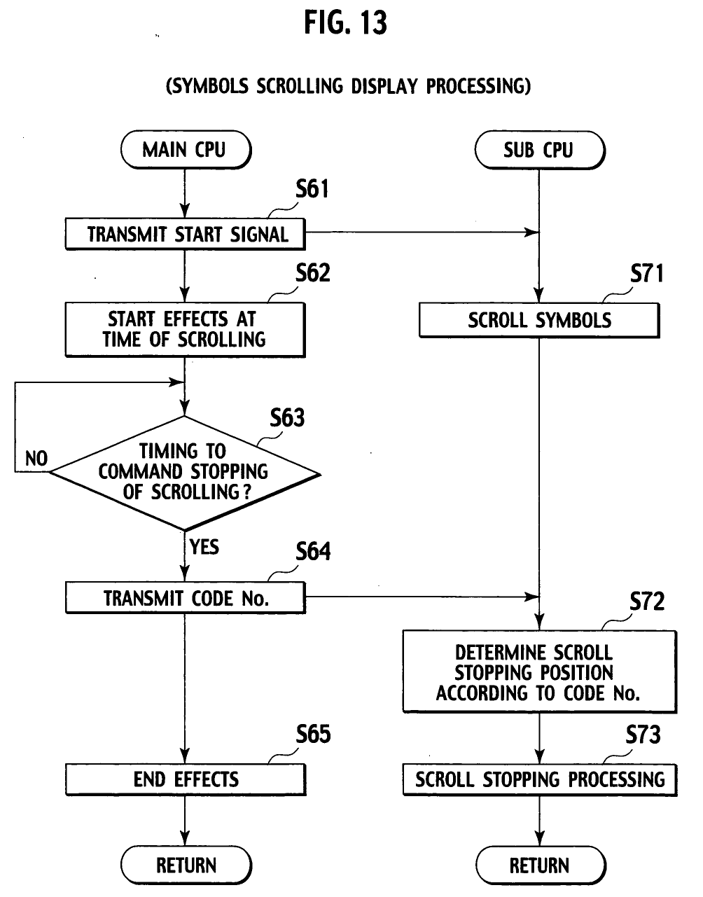

FIG. 13 is a flow chart showing a procedure of the symbols scrolling display processing shown at the step S15 of FIG. 7. This processing is a processing carried out between the main CPU 41 and the sub CPU 61.

First, the main CPU 41 transmits a start signal indicating that the symbols scrolling display will be started in the display regions 28 of the liquid crystal display 17, to the sub CPU 61 (step S61). Upon receiving the start signal from the main CPU 41, the sub CPU 61 outputs the symbols scrolling display command to the VDP 46, and the VDP 46 reads out the image data of symbols stored in the image data ROM 47, and carries out the scrolling of symbols in the display regions 28 (28a1 to 28e5) of the liquid crystal display 17 (step S71). As a result, the scrolling of symbols is started in the display regions 28.

After transmitting the start signal to the sub CPU 61 at the step S61 shown in FIG. 13, the main CPU 41 executes the effects at a time of the symbol scrolling (step S62). This processing is a processing for displaying the images on the lower side image display panel 16 and outputting sounds from the speaker 29, etc., during a period (three seconds, for example) determined according to the result of the symbols to be stopped determination processing (step S14 of FIG. 7), etc.

Next, the main CPU 41 judges whether it is a timing for commanding the stopping of the scrolling or not (step S63 of FIG. 13).

When it is judged that it is not a timing for commanding the stopping of the scrolling at the step S63, the processing is returned to the step S63 and the effects at a time of the scrolling are continued. When it is judged that it is a timing for commanding the stopping of the scrolling at the step S63, the main CPU 41 transmits the code numbers of symbols stored in the RAM 43 to the sub CPU 61 (step S64). Upon receiving the code numbers of symbols from the main CPU 41, the sub CPU 61 determines the symbols to be stopped such that they correspond to these code numbers (step S72).

After that, the scrolling stopping processing is carried out, and symbols are stopped and displayed in the display regions 28 (step S73). Also, the display processing of the effect images by the main CPU 41 is finished (step S65).

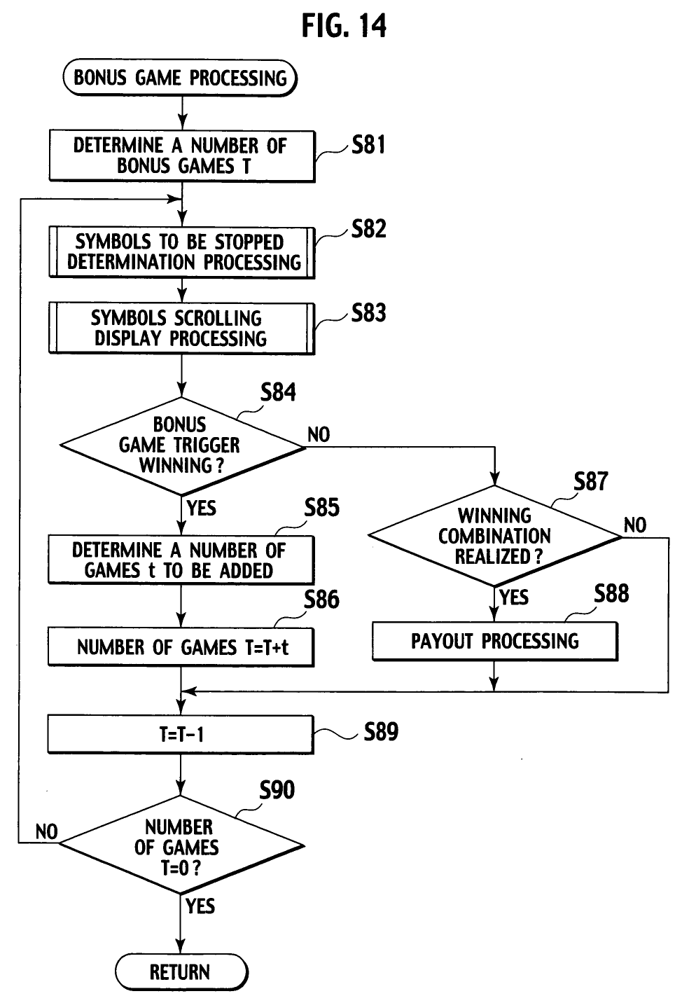

Next, a procedure of the bonus game processing shown at the step S22 of FIG. 8 will be described with reference to a flow chart shown in FIG. 14. In the bonus game processing, first, the main CPU 41 determines the number of times for executing the bonus game T from a range of 10 to 25 games, according to the random number value obtained by executing the random number generation program contained in the symbols to be stopped determination program stored in the RAM 43 (step S81). The main CPU 41 stores the determined data on the number of games T of the bonus game into the RAM 43.

Next, the main CPU 41 carries out the symbols to be stopped determination processing (step S82) and the symbols scrolling display processing (step S83). The processing of the step S82 is similar to the processing described above with reference to FIG. 12. The processing of the step S83 is similar to the processing described above with reference to FIG. 13. These processings have already been described above, so that their description will be omitted here.

Next, in FIG. 14, the main CPU 41 judges whether the bonus game trigger is realized or not, that is, whether the combination of symbols “APPLE” is stopped on the payline formed in the display regions 28 (28a1 to 28e5) inside the display windows 15 or not (step S84). When it is judged that the bonus game trigger is realized (step S84 YES), the number t of repetitions of the bonus game is newly determined (step S85), and the determined number t of repetitions is added to the current number of games T of the bonus game (step S86). In this way, when the bonus game is won again during the bonus game, the remaining number of the bonus games will be increased.

When the bonus game is not realized, the main CPU 41 judges whether the winning combination is realized or not (step S87). When it is judged that the winning combination is realized, the main CPU 41 makes the payout of coins according to the number of coins entered and the winning combination (step S88). At this point, the payout according to the first payout table shown in FIG. 4A is made.

When the processing of the steps S86 or S88 is executed, or when it is judged that any of the winning combinations is not realized at the step S87 (it is judged as a lost game), the main CPU 41 reads out the number of games T of the bonus game stored in the RAM 43, subtracts one from the read out value of the number of games T, and stores the number of games T after the subtraction into the RAM 43 again (step S89).

Next, the main CPU 41 judges whether the number of games T of the bonus game has reached the number of times determined at the step S81 or not (step S90). More specifically, it is judged by judging whether the number of games T stored in the RAM 43 has become zero or not, and when the number of games T is not zero, that is, when it is judged that the number of executed bonus games has not reached the number of times determined at the step S81, the processing is returned to the step S82 and the above described processing is repeated.

On the other hand, when the number of games T is zero, that is, when it is judged that the number of executed bonus games has reached the number of games T determined at the step S81, the processing is finished. The bonus game is carried out in this way.

FIG. 15 is a diagram showing an exemplary display on the upper side image display panel 33 and the lower side image display panel 16. As shown in FIG. 15, in the case where the identical symbols are displayed at both ends of the two cross lines L1 and L2 and the stop control game is started, letters “Symbol can be stopped by pressing a button” are displayed in the upper side image display panel 33, and further an image 92 of letters “LOOK UP!” is displayed in the lower side image display panel 16.

Next, the exemplary display to be displayed in the display regions 28 of the liquid crystal display 17 will be described with references to FIG. 16 to FIG. 22. FIG. 16 is a diagram showing a state when the stop control game is started in the central display region 28c3, in a state where the symbols “PLUM” are stopped at both ends of the cross line L1 and the symbols “BELL” are stopped at both ends of the cross line L2. As shown in FIG. 16, the background of the central display region 28c3 is brightened, so as to notify the player that the stop control game is possible in this display region 28c3.

FIG. 17 is a diagram showing an exemplary display when the symbol “BELL” is stopped in the central display region 28c3 by the stop control game.

FIG. 18 is a diagram showing an exemplary display when the cross symbol of “PLUM” and “BELL” is stopped in the central display region 28c3 by the stop control game.

FIG. 19 is a diagram showing an exemplary display when the symbols “PLUM” are aligned on the cross line L1 and the symbols “BELL” are aligned on the cross line L2, from a state shown in FIG. 18.

FIG. 20 is a diagram showing an exemplary display when the symbol “JACKPOT 7” is stopped in the central display region 28c3 by the stop control game.

FIG. 21 is a diagram showing an exemplary display when the symbol “JACKPOT 7” is stopped in the central display region 28c3 by the stop control game, and in the symbol “JACKPOT 7” is held in the subsequent base game.

FIG. 22 is a diagram showing an exemplary display when the symbol “WILD” is stopped in the central display region 28c3 by the stop control game. In this case, the symbol “WILD” can be used as any symbol, so that when the identical symbols are aligned on the payline including the symbol “WILD”, the winning combination is realized.

In this way, in the slot machine according to the present embodiment, when the identical symbols are stopped at both ends of the cross line L1 or L2 that is set as the paylines and when the winning combination is realized on this cross line, the payout amount is determined by selecting the second payout table with a greater payout amount than the first payout table that is ordinarily used, and the payout is made. Consequently, when the identical symbols are stopped at both ends of the cross line L1 or L2, it is possible to arouse the expectation of getting a greater payout in the player.

Also, when the identical symbols are stopped at both ends of the cross line L1 or L2, these symbols are held over a prescribed number of subsequent base games, so that it is possible to arouse the expectation of getting a greater payout in the player over several games.

In addition, when the identical symbols are stopped at both ends of the cross line L1 or L2, the stop control game for stopping the scrolling symbol by the operation of the player is executed in the display region 28c3 at its center. Consequently, it is possible to arouse even greater expectation in the player who tries to realize the winning combination.

Also, when the identical symbols are displayed at both ends of the two cross lines L1 and L2 and the symbols displayed at both ends are different for these cross lines, the cross symbol which commonly uses these symbols (the cross symbol of “PLUM” and “BELL” shown in FIG. 18, for example) is scrolled and capable of being stopped, so that it is possible to realize the winning combinations on the two cross lines L1 and L2 simultaneously, so that it is possible to arouse even stronger expectation of getting a greater payout in the player.

In addition, when the symbol “JACKPOT 7” is stopped by the stop control game, this symbol “JACKPOT 7” is held over a plurality of subsequent base games such that the possibility for having the symbol “JACKPOT 7” aligned becomes high, so that it is possible to arouse the great expectation of getting a greater payout in the player.

Also, when the symbol “WILD” is stopped by the stop control game, the possibility for realizing the winning combination by using this symbol “WILD” becomes high, and this symbol “WILD” is changed to the symbol “JACKPOT 7” and held over a plurality of subsequent base games such that the possibility for having the symbol “JACKPOT 7” aligned becomes high in the subsequent base game, so that it is possible to arouse the great expectation of getting a greater payout in the player.

In the above, the embodiment of the slot machine according to the present invention has been described, but it is only showing a concrete example which should not limit the present invention in any particular way, and the concrete configuration of each means or the like can be appropriately changed by design. Also, the effects described in the embodiment of the present invention are only listing the most preferable effects arising from the present invention, and the effects of the present invention are not limited to those described in the embodiment of the present invention.

What is claimed is:

1. A slot machine comprising:
a display having a rectangular display region in which a plurality of symbols can be arranged and at least two paylines set in the display region on diagonal lines of the display region; and
a controller operable to rearrange symbols in the display region, and enable a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region.

2. The slot machine of claim 1, wherein when the identical symbols rearranged at both ends of each payline on one of the diagonal lines are rearranged on the each payline again, the controller is operable to generate a payout greater than that generated when the identical symbols are rearranged on a payline other than the paylines on the diagonal lines.

3. The slot machine of claim 1, wherein when the identical symbols are rearranged at both ends of each one of the two paylines on the diagonal lines, the controller is subsequently to operable to hold the identical symbols over a prescribed number of games.

4. A slot machine comprising:
a display having a rectangular display region in which a plurality of symbols can be arranged and at least two paylines set in the display region on diagonal lines of the display region; and
a controller operable to rearrange symbols in the display region, enable a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region, and generate a greater payout when the identical symbols rearranged at both ends of each payline on one of the diagonal lines are rearranged on the each payline again, than that generated when the identical symbols are rearranged on a payline other than the paylines on the diagonal lines.

5. The slot machine of claim 4, wherein when the identical symbols are rearranged at both ends of each one of the two paylines on the diagonal lines, the controller is subsequently operable to hold the identical symbols over a prescribed number of games.

6. A slot machine comprising:
a display having a rectangular display region in which a plurality of symbols can be arranged and at least two paylines set in the display region on diagonal lines of the display region; and
a controller operable to rearrange symbols in the display region, enabling a rearrangement of at least one of a cross symbol, a wild symbol, and a jackpot symbol on an intersection of the two paylines on the diagonal lines by accepting an external input, in a case where identical symbols are rearranged at both ends of each one of the two paylines on the diagonal lines of the display region, generate a greater payout when the identical symbols rearranged at both ends of each payline on one of the diagonal lines are rearranged on the each payline again, than that generated when the identical symbols are rearranged on a payline other than the paylines on the diagonal lines, and subsequently to hold the identical symbols over a prescribed number of games when the identical symbols are rearranged at both ends of each one of the two paylines on the diagonal lines.

7. A playing method of a slot machine comprising:
rearranging symbols in a rectangular display region provided on a display by a controller; and
enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region.

8. The playing method of a slot machine of claim 7, wherein when the identical symbols rearranged at both ends of each payline on one of the diagonal lines are rearranged on the each payline again, the controller generates a payout greater than that generated when the identical symbols are rearranged on a payline other than the paylines on the diagonal lines.

9. The playing method of a slot machine of claim 7, wherein when the identical symbols are rearranged at both ends of each one of the two paylines on the diagonal lines, the controller subsequently holds the identical symbols over a prescribed number of games.

10. A playing method of a slot machine comprising:
rearranging symbols in a rectangular display region provided on a display by a controller;
enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region; and
generating a greater payout by a controller when the identical symbols rearranged at both ends of each payline on one of the diagonal lines are rearranged on the each payline again, than that generated when the identical symbols are rearranged on a payline other than the paylines on the diagonal lines.

11. The playing method of a slot machine of claim 10, wherein when the identical symbols are rearranged at both ends of each one of the two paylines on the diagonal lines, the controller subsequently holds the identical symbols over a prescribed number of games.

12. A playing method of a slot machine comprising:
rearranging symbols in a rectangular display region provided on a display by a controller;
enabling a rearrangement of at least one of a cross symbol, a wild symbol, and a jackpot symbol on an intersection of two paylines on diagonal lines by accepting an external input by a controller, in a case where identical symbols are rearranged at both ends of each one of the two paylines on the diagonal lines of the display region;
generating a greater payout by a controller when the identical symbols rearranged at both ends of each payline on one of the diagonal lines are rearranged on the each payline again, than that generated when the identical symbols are rearranged on a payline other than the paylines on the diagonal lines; and
subsequently holds the identical symbols over a prescribed number of games by a controller when the identical symbols are rearranged at both ends of each one of the two paylines on the diagonal lines.
